(19) United States
(12) Patent Application Publication
(10) Pub. No.: US 2022/0188958 A1
(43) Pub. Date: Jun. 16, 2022

(54) NETWORK SYSTEM FOR CONTROLLING COMMUNICATIONS BASED ON USER CONTEXT

(71) Applicant: Uber Technologies, Inc., San Francisco, CA (US)

(72) Inventors: Sudharsan Vasudevan, San Francisco, CA (US); Thomas Hofman, San Francisco, CA (US); Robin Hunter, San Francisco, CA (US); Yashashvi Kapalli, San Francisco, CA (US); Kyle Chiang, San Francisco, CA (US)

(21) Appl. No.: 17/550,225

(22) Filed: Dec. 14, 2021

Related U.S. Application Data
(60) Provisional application No. 63/126,367, filed on Dec. 16, 2020.

(51) Int. Cl. G06Q 50/30; G01C 21/34; H04W 4/02; H04W 4/40; H04L 67/52

(52) U.S. Cl. CPC G06Q 50/30; G01C 21/3438; H04L 67/18; H04W 4/40; H04W 4/02

(57) ABSTRACT

A computing system can receive transport requests from requesting users and attempt to match each transport request with a transport provider to transport the requesting user to a destination. Based on a cancelation request from the requesting user received prior to a match being made, the system can determine one or more alternative options for fulfilling the transport request based on one or more attributes indicated in a user profile of the requesting user, and cause a service application executing on the computing device of the requesting user to initiate an interactive mode to display contextual information associated with the matching process, and provide of the one or more alternative options for fulfilling the transport request.

### CROSS-REFERENCE TO RELATED APPLICATION

This application claims the benefit of priority to U.S. Provisional Application No. 63/126,367, filed on Dec. 16, 2020, which is hereby incorporated by reference in its entirety.

### BACKGROUND

Systems and services that algorithmically coordinate transport services continue to improve in precision, computation of estimated arrival and drop-off times, and reliability.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example computing system in communication with computing devices of requesting users and transport providers, in accordance with examples described herein;

FIG. 2A is a flow chart describing a pre-match method of initiating an interactive mode to fulfill a transport request, according to examples described herein;

FIG. 2B is a flow chart describing a pre-match method of predicting and preempting cancelation to fulfill a transport request, according to examples described herein;

FIG. 3A is a flow chart describing a post-match method of initiating an interactive mode to fulfill a transport request, according to examples described herein;

FIG. 3B is a flow chart describing a post-match method of predicting and preempting cancelation to fulfill a transport request, according to examples described herein;

FIGS. 4A and 4B depict user interfaces showing interactive features and updates prior to a match, in accordance with examples described herein;

FIGS. 5A and 5B depict user interfaces showing interactive features and updates subsequent to a match, in accordance with examples described herein;

FIGS. 6A and 6B depict user interfaces showing interactive features presenting an alternative service option, in accordance with examples described herein;

FIG. 7 is a block diagram illustrating an example mobile computing device, in accordance with examples described herein; and

FIG. 8 is a block diagram that illustrates a computer system upon which examples described herein may be implemented.

### DETAILED DESCRIPTION

Embodiments described herein include a computing system that coordinates transport services by exchanging data with computing devices over one or more networks. In some examples, upon submitting a transport request to the computing system, a requesting user may subsequently cancel the request for any number of reasons, such as match delay, long estimated arrival time of a transport provider, a change in plans, lack of driver movement, and the like. In another example, in certain scenarios, a transport provider, who may have been matched with a requesting user and may have accepted an invitation to provide a transport service (e.g., a trip), may cancel the trip for any number of reasons, such as traffic, undesirable travel direction, etc. In other scenarios, for example, the backend computing system facilitating transport request matching may decide to cancel the request due to lack of transport supply in a vicinity of the requesting user. In each of these scenarios, current systems would terminate the matching process and leave it up to the requesting user to decide whether to make a new request for service.

According to examples described herein, a computing system can create, manage, and/or maintain interactive communications or communication sessions with a requesting user's device based on predicting or determining a cancelation event. As used herein, a “cancelation event” refers to a requesting user canceling a transport request prior to being matched with a transport provider, or after being matched to a transport provider. A cancelation event may also refer to the transport provider canceling a match with a requesting user, or the computing system canceling a transport request or match based on a number of factors (e.g., lengthy ETA for available transport providers). The computing system can remotely facilitate an on-demand transport service, and can include a network communication interface to communicate, over one or more networks, with (i) a service application executing on computing devices of requesting users of the on-demand transport service, and (ii) a provider application executing on computing devices of transport providers of the on-demand transport service. The system can further include a database storing user profiles for the requesting users, where each user profile for each corresponding requesting user indicates user-specific attributes of the corresponding requesting user. The system includes one or more processors and a memory storing instructions that, when executed by the one or more processors, cause the computing system to perform a set of predictive and solution-based operations in order to fulfill transport requests that would otherwise go unfulfilled due to a cancelation request.

The system can receive a transport request from the computing device of a requesting user, where the transport request indicates a start or pickup location and/or a desired destination. The system can further receive location data from the computing devices of a set of candidate transport providers that are proximate to the pickup location indicated in the transport request. Based on data from the transport request and the location data, the system initiates a matching process to match the requesting user with a selected transport provider. In various implementations, the system may also execute a predictive model (e.g., by running one or more microservices that run on the system), using the user's attributes stored in the user profile of the requesting user (e.g., the user's contextual data) and/or other contextual data or marketplace information, such as current cost or amount for the current trip or amount of available transport providers in an area or geographic region associated with the pickup location, to compute or output a prediction (or repeated or periodic predictions) of whether the requesting user will cancel the transport request within a future given time period (e.g., a probability of cancelation within the next five seconds).

In response to at least one of the predictions crossing a certainty threshold of the predictive model (e.g., a 95% configurable confidence level that the requesting user will cancel the transport request), the system can initiate an interactive mode on the transport service application executing on the computing device of the requesting user in order to prevent the predicted cancelation. In certain examples, this interactive mode may also be triggered based on an explicit cancelation or trip-termination signal from the rider or from the transport provider. The interactive mode can cause the service application to generate a set of user interface features that (i) provide the requesting user with contextual information concerning the matching process, and (ii) provide the requesting user with one or more alternative options for fulfilling the transport request. Such options can be individualized to the requesting user based on the unique attributes of the requesting user. For example, if the requesting user has a propensity of utilizing or accepting alternative transport types (e.g., a high-capacity vehicle instead of a regular vehicle), then the system can present an option to upgrade or downgrade to a different transport type, depending on availability within the vicinity of the requesting user. Furthermore, the contextual information presented to the user can provide transparency to the user regarding, for example, the causes of a delay in the matching process or a lengthy estimated time of arrival (ETA) of the transport provider, thereby increasing user engagement with the on-demand transport service.

In further examples, the system can provide a different set of treatment content based on the specified time and manner of the cancelation or predicted cancelation. In a first scenario, the system may predict a user cancelation will occur prior to the user being matched with a transport provider. In a second scenario, the system may predict a user cancelation will occur after the user has been matched with a transport provider. And, in a third scenario, the system may predict unfulfillment due to a system-initiated cancelation of the transport request, which may occur due to, for example, a lack of transport supply within a certain proximity of the requesting user. Described below in connection with the drawings are the differing interactions and treatment responses, comprising combinations of notifications, recommendations, and/or selectable alternative service options provided to the requesting user for each of these scenarios. Furthermore, each set of treatment interactions for each scenario may be individually tailored to the requesting user based on the user-specific attributes that the system has learned about the requesting user based on historical data corresponding to the user's historical engagement with the on-demand transport service and other current or past marketplace data such as price of the trip, transport provider availability information, and the like.

Among other benefits, embodiments described herein provide a technical effect of applying a predictive model using the user-specific attributes of a requesting user to predict whether the requesting user will cancel a transport request and preventing the predicted cancelation (pre-match or post-match) using an interactive mode on a service application. For example, based on the user-specific attributes of the user and the nature of the predicted cancelation, the system can generate a customized set of alternative options, notifications, and/or service recommendations individually tailored for the user to increase the user's engagement and satisfaction with the on-demand transport service. Moreover, by predicting user cancelation of service and preemptively performing certain functions in response to such predictions (e.g., identifying one or more alternative options in fulfilling the user's transport request), the computing system can improve user interactions with the service application. For instance, information relating to the one or more alternative options in fulfilling the user's transport request can be pre-computed (e.g., prior to the user's cancelation input), cached on the user device, and caused to be displayed on the user device in real-time or near real-time. In comparison, in prior systems and implementations, the user may experience delays in being presented with such information.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### SYSTEM DESCRIPTION

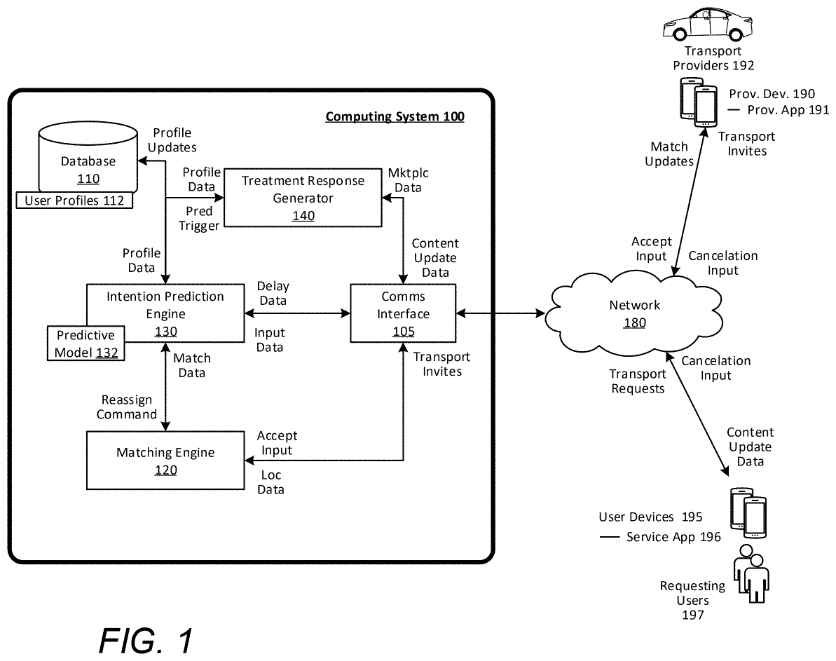

FIG. 1 is a block diagram illustrating an example computing system 100 in communication with user devices 195 of requesting users 197 and provider devices 190 of transport providers 192, in accordance with examples described herein. The computing system 100 can include a communication interface 105 that connects, over a network 180, with the provider devices 190 and user devices 195 of the transport providers 192 and requesting users 197 (e.g., via a dedicated transport provider app 191 and service app 196 respectively). In various implementations, a requesting user 197 can select the transport service app 196 to configure and transmit a transport request, which can indicate a pickup location and a destination. As provided herein, the transport provider 192 can comprise a human driver operating a particular vehicle (e.g., an automobile, air taxi, airplane, helicopter, boat, etc.), or can comprise an autonomously operated vehicle.

In various examples, the transport request may further indicate a transport service type, which can comprise a standard or default rideshare service type in which the requesting user 197 is transported by an available transport provider 192 in a default or standard vehicle (e.g., a compact or mid-sized car), a carpool service type in which the requesting user 197 may share the ride with other requesting users 197 that have pick-up or drop-off locations that correspond to a route or general direction of travel of the requesting user 197, an express carpool service type or a walk-and-ride service type in which the pickup and/or destination location of the requesting user 197 is flexible and may require the requesting user 197 to walk a certain distance, a luxury service type in which the requesting user 197 is transported in a luxury vehicle by a professional driver, a comfort service type in which the requesting user 197 is matched with a vehicle having more space and/or legroom, a high capacity vehicle service type in which the requesting user 197 is matched with a vehicle providing more seats and/or cargo space (e.g., a sport utility vehicle or van), a luxury high-capacity vehicle service type in which the requesting user 197 is transported in a large vehicle (e.g., a sport utility vehicle) by a professional driver, a special assistance service type in which the requesting user 197 requires special assistance (e.g., entering or exiting the vehicle), a wheelchair accessible vehicle service type, a green transport service type in which the requesting user 197 is matched with an electric or hybrid vehicle, and the like. Each transport service type may correspond to a different pricing model. For example, the lowest price service type is generally the express carpool or walk-and-ride option, whereas the highest priced option is generally the luxury vehicle or the high-capacity vehicle option.

The computing system 100 includes a matching engine 120 that receives location data from the provider devices 190 of available transport providers 192 (e.g., from a positioning system via the executing transport provider app 191), and determines a set of candidate transport providers 192 that are within a certain proximity or time to the pickup location indicated in the transport request. In certain scenarios, the matching engine 120 may not identify any candidate transport providers 192 to service the transport request (e.g., based on lack of transport provider supply). For example, there may be no available transport providers 192 within a threshold proximity (e.g., five kilometers) or a threshold ETAs (e.g., ten minutes) from the pickup location. In such scenarios, the matching engine 120 may extend the thresholds to a wider proximity and/or longer ETA in order to attempt to identify any candidate transport providers 192 to service the transport request. Additionally or alternatively, the matching engine 120 may wait to determine if any transport providers 192 become available or otherwise come online within the threshold proximity or ETA.

In most scenarios, the matching engine 120 identifies a candidate set of transport providers 192 to service the transport request based on distance and/or ETA to the pickup location, and/or based on the marketplace conditions within a sub-region in which the requesting user 197 is located (e.g., the driver supply versus transport demand and/or the movement of transport supply within the sub-region). Upon selection of an optimal transport provider 192 that matches the service type configured by the requesting user 197, the matching engine 120 transmits a transport invitation to the provider device 190 of the optimal transport provider 192, who may then accept the invitation or decline the invitation for any reason. When the transport provider 192 accepts, the transport provider 192 may provide an acceptance input, which indicates that the transport provider 192 will rendezvous with the requesting user 197 at the pickup location and transport the requesting user 197 to the desired destination.

In certain scenarios, a situational trigger will cause either the matching engine 120, the transport provider 192, or the requesting user 197 to cancel the transport request or the match between the requesting user 197 and transport provider 192. Current implementations treat the actual cancelation as an end to the process, requiring the requesting user 197 to configure and transmit a new transport request. Described herein are process extensions that treat each of several predicted and/or actual cancelation scenarios in a strategic manner in order to provide context and transparency concerning the situational triggers (e.g., matching delays, lengthy ETAs, lack of transport supply for a selected service option, etc.), and provide alternative options to prevent the cancelation event, or in response to the cancelation event.

According to examples provided herein, the computing system 100 includes a database 110 comprising user profiles of the requesting user 197 and transport providers 192. Each user profile 112 can include historical information of a corresponding requesting user 197 or transport provider 192. For requesting users 197, the user profile 112 can indicate trip history, such as how frequently the requesting user 197 uses the on-demand transport service, which transport service types the requesting user 197 selects, common pick-up and drop-off locations of the requesting user 197, and other engagement information. According to examples provided herein, the user profile 112 can further indicate a set of user-specific attributes of the requesting user 197. These user-specific attributes can generally correspond to the requesting user's 197 patience, impatience, openness to upgrading service types or selecting alternative service types, price sensitivity, and the like. For example, the user profile 112 can include cancelation data of the requesting user 197, which can indicate the conditions, context, and/or factors that contribute to the requesting user's 197 decision(s) to cancel a transport request or a match (e.g., lengthy ETA of the transport provider 192, delay in matching the requesting user 197 with a transport provider 192, lack of indicated movement by the transport provider 192, stalled or increasing ETA of the transport provider 192 to the pickup location, etc.).

In various implementations, the computing system 100 includes an intention prediction engine 130 that executes a predictive model 132 to predict whether the requesting user 197, the transport provider 192, and/or the matching engine 120 will cancel the transport request or match. Specifically, upon receiving a transport request from a requesting user 197, the intention prediction engine 130 can retrieve profile data of the requesting user 197 from the user's profile 112 and execute the predictive model 132 using the user-specific attributes of the requesting user 197 in order to predict whether the requesting user 197 will terminate the transport request. Additionally or alternatively, the intention prediction engine 130 can further monitor the input data of the requesting user 197 on the user interface of the service app 196 (e.g., zooming inputs, scrolling inputs, selection inputs, viewed screens, etc.), which can also be processed by the predictive model 132 in real time to compute the cancelation probability. Further still, delay data can be monitored by the intention prediction engine 130 and processed by the predictive model 132 in real time to compute the cancelation probability. The delay data can correspond to any factors contributing to either a delay in making a match (e.g., lack of transport supply), or a delay in the rendezvous between the requesting user 197 and transport provider 192 after a match has been made (e.g., traffic conditions, a driver detour, etc.).

It is contemplated that the delay data and/or marketplace condition information can be cached and utilized by the intention prediction engine 130 and/or matching engine 120 as a signal for additional matches or predictive determinations. For example, the matching engine 120 can access the cached delay data and marketplace condition information for making decisions regarding optimal supply movement (e.g., providing transport invitations or notifications to transport providers 192 to move them into supply constrained sub-regions). As another example, the cached delay data and marketplace condition information can further be utilized by the predictive model 132 in making cancelation predictions for other requesting users 197 and transport providers 192 in specified sub-regions where the cached data is relevant (e.g., within a certain radius of a requesting user 197 that has canceled or was predicted to cancel within a past amount of time, such as the past minute). By utilizing the cached data as opposed to initiating new computations without the cached data, hardware latency on the computing system 100 is significantly reduced, particularly when considering that the computing system 100 may coordinate and facilitate on-demand transport throughout relatively large regions (e.g., entire metropolises). Furthermore, the matching engine 120 can utilize the cached data to make more strategic matches and decisions that may have an overall impact of optimizing the marketplace as a whole, such as coordinating the movement of transport supply via matches to balance transport supply with transport demand across all sub-regions of the overall transport service region.

The predictive model 132 can output a continuous or periodic cancelation probability. When this probability of cancelation exceeds a certain confidence threshold (e.g., 95%), the intention prediction engine 130 can output a predictive trigger to a treatment response generator 140 of the computing system 100, which can provide a selected set of interactive features to interact with the requesting user 197, as described below. If the confidence threshold is never exceeded, but an actual cancelation input is received from the requesting user 197 (e.g., the selection of a cancelation icon or a swipe gesture to cancel), the cancelation input can comprise an actual trigger for the treatment response generator 140. In addition or as an alternative, the treatment response generator 140 can be triggered by a user input (e.g., a swipe gesture) to open a menu within the service application or a combination of receiving such a user input and the determined probability of cancelation exceeding some threshold value (e.g., a second confidence threshold, 75%). For instance, a user interface feature to cancel the transport request may be presented within the menu of the service application. And, in response to receiving the user input to open the menu (i.e., prior to the user being presented with the cancelation user interface feature) and the determination that the probability of cancelation exceeds a second confidence threshold (e.g., a lower threshold than the 95% confidence threshold, 75%), the functionalities of the treatment response generator 140 can be triggered.

Depending on the timing of the predictive trigger indicating the predicted cancelation or actual cancelation trigger, the treatment response generator 140 generates and provides content update data to the user device 195 of the requesting user 197, where the content update data can correspond to notifications, contextual information concerning potential causes, a recommended alternative, a set of selectable alternative transport options, etc. The time windows of the predicted cancelation that determine the type of treatment response can correspond to (i) the requesting user 197 having submitted a transport request but not yet being matched with a transport provider 192 (pre-match), or (ii) the requesting user 197 or the transport provider 192 canceling after a match has been made but prior to the rendezvous (post-match). For these two timing windows, individualized treatment content (e.g., notifications and/or recommendations) and/or interactive features (e.g., alternative service options) can be provided to the requesting user 197 based generally on the profile data in the user's profile 112 and current marketplace conditions in the vicinity of the requesting user 197 (e.g., alternative available service options and/or transport providers 192 within a certain proximity or ETA to the requesting user 197).

In additional implementations, the intention prediction engine 130 can execute the predictive model using the user-specific attributes of a transport provider 192 that has been matched with the requesting user 197 in order to determine whether the transport provider 192 will cancel the match. Similar to the requesting user 197, once the confidence threshold is exceeded for the transport provider 192, the intention prediction engine 130 can output the predictive trigger to the treatment response generator 140, which may then select and provide individualized treatment content or interactive features to the provider device 190 of the transport provider 192 to prevent the cancelation and/or the user device 195 of the requesting user 197 to mitigate the effects of the cancelation.

As described herein, the type of treatment content is determined based on the time window in which the predictive or actual trigger is received, which party is predicted to cancel or actually cancels the transport request or match, and/or whether the matching engine 120 will cancel the transport request (e.g., due to lack of available transport supply and/or an expiration time, such as thirty seconds, being exceeded). Accordingly, the cancelation trigger (predictive or actual) can include one or more classifiers indicating which party is predicted to cancel and which time window the cancelation is predicted to occur.

For the pre-match time window, the treatment response generator 140 can analyze the marketplace data within a certain area of the requesting user 197 or pickup location. In doing so, the treatment response generator 140 can identify one or more available and/or unavailable transport providers 192 within the area, regardless of vehicle type and service type (e.g., including luxury vehicles, carpool service vehicles, SUVs, etc.), and in certain examples, determine theoretical ETAs of each identified transport provider 192 to the pickup location of the requesting user 197. In certain examples, the treatment response generator 140 may also calculate a probability that the requesting user 197 will receive a match within a certain timeframe (e.g., the next ten seconds).

Based on this match probability, the treatment response generator 140 can perform any combination of the following actions. If a transport provider 192 has been provided with a transport invitation for the request and the matching engine 120 is awaiting a response, the treatment response generator 140 can transmit a transparent, contextual notification to the user device 195 of the requesting user 197 to inform the requesting user 197 of the status of the transport request (e.g., “we are awaiting a response from a transport provider 192 that is within a five minute ETA to you, would you like to wait a few more seconds?,” or “there are vehicles in your vicinity, and we are currently finding the closest one to you.”). The contextual notification provides the requesting user 197 with a choice, and can include one or more selectable icons or other interactive features that enable the requesting user 197 to select in the affirmative (e.g., the user 197 is willing to wait) or the negative (e.g., the requesting user 197 wishes to cancel). Upon receiving a user selection in the affirmative, the matching engine 120 can keep the request open and continue the matching process.

At any given time, the requesting user 197 may not be engaging with the user interface of the service application 196. The treatment response generator 140 can detect whether the user interface is currently displayed, and if not (e.g., the service app 196 is idle or running as a background app), any of the notifications, recommendations, and/or selectable alternative options described herein can comprise a push notification, a text message, an email, etc., and can be presented currently with a corresponding audio and/or haptic output. If the user interface of the service app 196 is currently displayed on the user's computing device 195, then the notifications, recommendations, and/or selectable alternative options described herein can be presented on the user interface accordingly. Furthermore, at any given time, the treatment response generator 140 may provide a call or text feature on the user interface of the service app 196 or through a push notification that enables the requesting user 197 to directly communicate with a matched transport provider 192.

When the match probability indicates that the requesting user 197 is likely not to be matched with a transport provider within a certain amount of time (e.g., >20% probability in the next five minutes), the treatment response generator 140 can transmit a content update to the user device 195 of the requesting user 197 to present the requesting user 197 with a contextual notification describing the scenario to the requesting user 197 and selectable choices of whether the user 197 is willing to wait for an additional period of time (e.g., five or ten minutes) or not. It is contemplated that this low match probability can correspond to a predictive cancelation trigger for the requesting user 197 or a predictive trigger for the matching engine 120 (e.g., that a match is unlikely to be made before an expiration time is reached). Upon receiving a user selection in the affirmative, the matching engine 120 can keep the request open and continue the matching process accordingly.

In various examples, upon receiving a cancelation trigger (predictive or actual), the treatment response generator 140 can utilize the marketplace data—which may be cached from a previous analysis, real-time marketplace data, or a combination of the two—and identify one or more alternate transport providers 192 providing the same or one or more alternative transport service types (e.g., carpool, luxury, SUV, etc.) within a certain proximity of the requesting user 197. Based on (i) the ETA and/or cost of the alternative transport provider(s) 192, (ii) the user-specific attributes indicated in the profile data of the requesting user 197, and/or (iii) the current marketplace conditions, the treatment response generator 140 may identify a most optimal alternative option for the requesting user 197, and transmit a recommendation indicating the alternative option, the ETA and cost for selecting the alternative option, and a selectable feature enabling the requesting user 197 to select and confirm the alternative option. As provided herein, the recommendation may be individualized for the requesting user 197 based on the user's user-specific attributes, such as historical upgrade information and/or previous selections of other service types.

In some implementations, the alternative option recommendation may further be based on a lack of transport supply or lengthy wait times for the original service type selected by the requesting user 197 when configuring the transport request. Additionally or alternatively, the treatment response generator 140 may present a list of alternative options each accompanied by a corresponding price and ETA. Each option may be selectable by the requesting user 197 to cause the matching engine 120 to instigate the match. In still further examples, the list of alternative options and/or the alternative option recommendation may be presented to the requesting user 197 prior to the predictive cancelation trigger to provide the requesting user 197 with a choice to upgrade or downgrade accordingly. In such examples, the matching engine 120 may identify marketplace efficiency benefits if the requesting user 197 were to be matched with a different transport provider 192 and/or service type. Accordingly, providing the preemptive alternative recommendation and/or list of alternative options may be triggered by the matching engine 120 indicating marketplace efficiency benefits, such as supply movement benefits in general or for particular service types.

For the post-match time window in which the requesting user 197 or transport provider 192 is predicted to cancel after being matched, the treatment response generator 140 can analyze contextual information with regards to the match and determine one or more causes for the predicted cancelation. The contextual information can indicate that the matched transport provider 192 has not moved or has moved slowly since accepting the transport invitation. It is observed that this is a primary reason for cancelations to occur post-match, so this delay information may also factor into the predictive cancelation trigger being outputted by the predictive model 132 of the intention prediction engine 130. In this scenario, the treatment response generator 140 may transmit a transparent, contextual notification expressing awareness of the delayed transport provider 192. Additionally or alternatively, the treatment response generator 140 may provide a recommendation to cancel the request. If the requesting user 197 cancels based on this recommendation, the matching engine 120 can automatically initiate a new matching process for the same transport request without the requesting user 197 having to configure a new one, and can exclude the delayed transport provider 192 from the new process.

When the contextual information indicates that the matched transport provider 192 is moving, but the ETA to the pickup location is high (e.g., more than ten minutes), the treatment response generator 140 can evaluate the current marketplace data to determine whether any transport providers 192 of the same and/or different service type have a lower ETA to the pickup location. If so, the treatment response generator 140 can transmit a notification acknowledging the high ETA of the matched transport provider 192, and an alternative transport provider 192 indicating the lower ETA. In some aspects, the treatment response generator 140 may flag the alternative transport provider 192 to temporarily prevent the alternative transport provider 192 from being matched with another transport request. The notification can include a selectable feature enabling requesting user 197 to initiate a reassignment. Upon selecting this feature, the matching engine 120 can receive a reassignment command from the treatment response generator 140 and automatically match the requesting user 197 with the alternative transport provider 192, while the unmatched transport provider 192 may be matched with a different transport request accordingly.

In further variations, the marketplace data may indicate a match inefficiency in which the match between the requesting user 197 and transport provider 192 and a second match would result in greater marketplace efficiency if the matches were swapped. In this scenario, the swap can be performed through match updates by the matching engine 120 automatically based on detecting the match inefficiency, or in response to one or more swap triggers, such as a predictive cancelation trigger in either of the matches. In the event of a long ETA, the treatment response generator 140 can transmit a contextual notification indicating awareness of the lengthy ETA and that it is analyzing the marketplace to determine whether any better options are available (e.g., for the same requested service type), including potential match swaps. In certain implementations, this contextual notification can include a selectable feature that enables the requesting user 197 to provide preemptive approval for automatically switching the requesting user 197 to a different match.

In still further variations, the marketplace data may indicate scarcity in transport supply conditions and that no better options are currently available. In this scenario, the treatment response generator 140 can provide a contextual notification to the requesting user 197 indicating that there are no better options for the requested service type, and that cancelation and resubmitting the transport request would result in the same match. Additionally or alternatively, the treatment response generator 140 can analyze the user-specific attributes of the requesting user 197 and the current marketplace conditions for alternative service types, and present a list of alternative options and/or a recommended alternative option, as described above.

It is contemplated that the implementations described herein will transition current matching techniques away from the current request-match-cancelation model, in which a cancelation of a request or match results in a failure of the existing process, and requires a new matching process to attempt a successful match and ride to the user's desired destination. The effect of canceling and re-requesting and the lack of transparency in current techniques has the effect of constraining untapped potential in providing positive user experience through engagement with the on-demand transport service. By providing predictive and treatment response capabilities on an individual level, and increased contextual transparency, user experience and user engagement with the on-demand transport service will significantly improve.

### METHODOLOGY

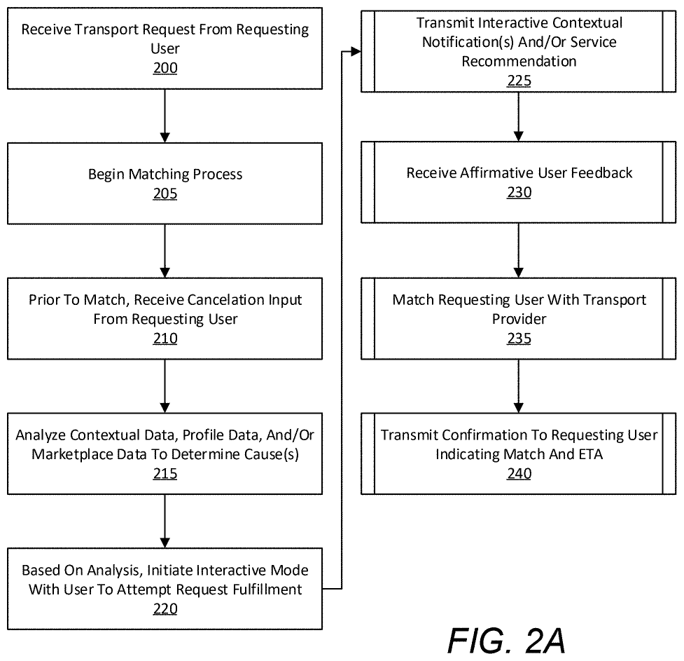

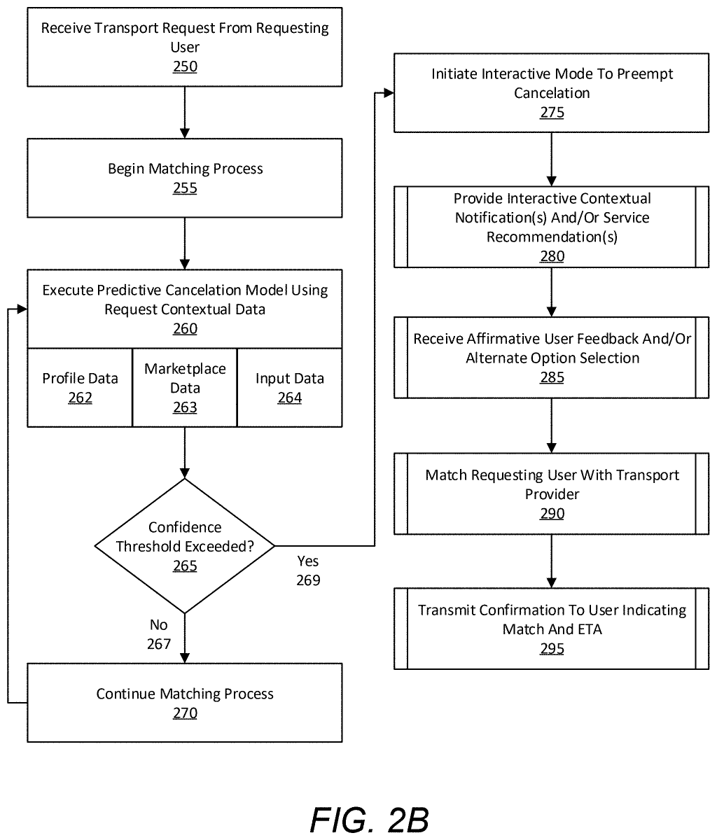

In the below processes described with respect to the flow charts of FIGS. 2A through 4B, reference may be made to reference characters representing like features as shown and described with respect to FIG. 1. Furthermore, the processes described below may be performed by the computing system 100, or a combination of the computing system 100 and user device 195 and/or provider device 190 as shown in FIG. 1. Still further, the steps described in the flow charts of FIGS. 2A through 4B need not be performed in any particular order, and any step may be performed in sequence with or in conjunction with any other step in any other flow chart.

FIG. 2A is a flow chart describing a pre-match method of initiating an interactive mode to fulfill a transport request, according to examples described herein. Referring to FIG. 2A, the computing system 100 can receive a transport request from a requesting user 197 (200). As provided above, the transport request can indicate a selected service type, a pickup location, and a destination of the requesting user 197. The computing system 100 may then begin a matching process to attempt to match the requesting user 197 with a transport provider 192 (205). Prior to the match, the computing system 100 can receive a cancelation input or request from the requesting user 197 (210). In certain supply constrained scenarios, this cancelation input or request may come from the matching engine 120 of the computing system 100 (e.g., due to an expiration time lapsing). In response to receiving the cancelation input or request, the computing system 100 can analyze contextual data corresponding to the transport request, profile data of the requesting user 197 (e.g., the user-specific user attributes), and/or marketplace data in a vicinity of the requesting user 197 to determine any potential cause(s) of the cancelation (215). As provided herein, these causes may provide the computing system 100 with a means for presenting interactive content to the requesting user 197.

Based on the analysis, the computing system 100 can initiate an interactive mode (e.g., via the service app 196) with the requesting user 197 to attempt to fulfill the transport request (220). In the interactive mode, the computing system 100 can transmit interactive contextual notifications and/or a service recommendation for the requesting user 197 based on the determined cause(s) of the cancelation (225). For example, the treatment response generator 140 described in connection with FIG. 1 can generate a set of interactive features that may be individualized or customized specifically for the requesting user 197 based on the current transport supply conditions around the requesting user 197, alternative transport service options around the requesting user 197, the requesting user's user-specific attributes based on historical data, and the like. Furthermore, the interactive features can comprise contextual notifications indicating, for example, the reason(s) for any delay to provide transparency to the requesting user 197, and can query the requesting user 197 for whether the requesting user 197 wishes to wait longer or confirm the cancelation.

In various examples, the computing system 100 can receive affirmative user feedback indicating that the requesting user 197 is willing to wait longer for a match given the contextual information provided (230). In response, the computing system 100 can continue the matching process and match the requesting user 197 with a transport provider 192 (235). The computing system 100 may then transmit a confirmation to the requesting user 197 to indicate the match with the transport provider 192 and an ETA to the pickup location (240).

FIG. 2B is a flow chart describing a pre-match method of predicting and preempting cancelation to fulfill a transport request, according to examples described herein. Referring to FIG. 2B, the computing system 100 can receive a transport request from a requesting user 197 (250). In response, the computing system 100 can begin the matching process, as described above (255). The computing system 100 may also execute a predictive model 132 using contextual data with regards to the transport request (260). The contextual data can comprise profile data of the requesting user 97 (262), marketplace data in the vicinity of the requesting user 197 (e.g., indicating scarce supply) (263), and/or input data corresponding to the user's interactions with the user interface of the service app 196 (e.g., indicating impatience or suggesting cancelation is imminent) (264). Execution of the predictive model 132 can be performed periodically or in-real time and can output a cancelation probability.

For each probability output, the computing system 100 can determine whether the cancelation probability exceeds a confidence threshold (e.g., 90% probability of cancelation by the requesting user 197) (265). If not (267), then the computing system 100 can continue with the matching process and the execution of the predictive model 132 (270). However, if the confidence threshold is exceeded (269), then the computing system 100 can initiate an interactive mode (e.g., via the service app 196) to preempt the predicted cancelation (275).

In the interactive mode, the treatment response generator 140 of the computing system 100 can transmit interactive contextual notifications to provide the requesting user 197 with information regarding any delays and/or service recommendations based on the profile data of the requesting user 197 and the current marketplace conditions (280). In these interactive features, the treatment response generator 140 of the computing system 100 can query the requesting user 197 for whether the requesting user 197 wishes to wait longer in light of the information provided. Additionally or alternatively, the interactive features can provide the requesting user 197 with information indicating shorter wait times for alternative service types, and the choice to select one or more alternative service types presented on the user interface. The treatment response generator 140 of the computing system 100 may receive affirmative feedback and/or an alternative service selection from the requesting user 197 (285). In response, the matching engine 120 of the computing system 100 can continue the matching process accordingly and match the requesting user 197 with an optimal transport provider 192 of the selected service type (290). The matching engine 120 of the computing system 100 may then transmit a confirmation to the requesting user 197 indicating the matched transport provider 192 and an ETA to the pickup location (295).

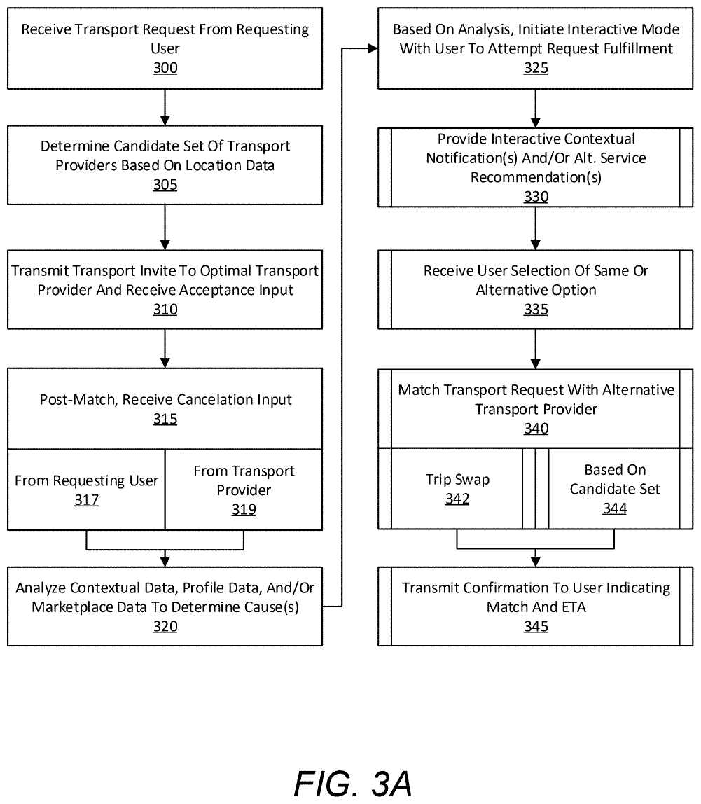

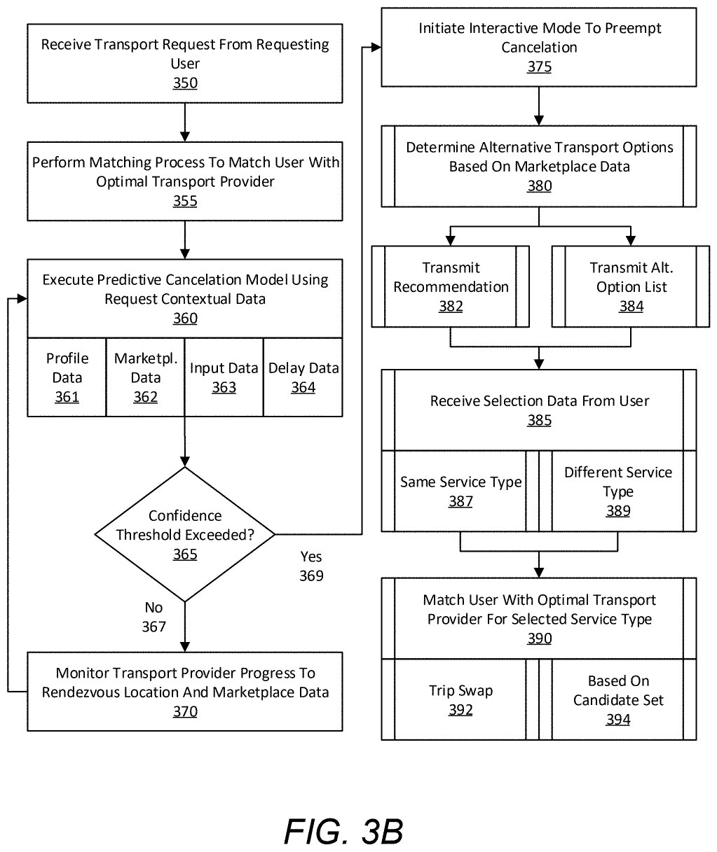

FIG. 3A is a flow chart describing a post-match method of initiating a interactive mode to fulfill a transport request, according to examples described herein. Referring to FIG. 3A, the computing system 100 can receive a transport request from a requesting user 197 (300). Based on location data received from transport providers 192, the matching engine 120 of the computing system 100 can determine a candidate set of transport providers 192 to service the transport request (305). The matching engine 120 of the computing system 100 may then transmit a transport invitation to an optimal transport provider 192 in the candidate set and receive an acceptance input accordingly, completing the match (310).

During the en route phase in which the transport provider 192 has accepted but has not yet arrived at the pickup location, the computing system 100 can receive a cancelation input or request to cancel the match (315). In one scenario, the cancelation input may be received from the requesting user 197 (317). Alternatively, the cancelation input may be received from the matched transport provider 192 (319). In response, the treatment response generator 140 of the computing system 100 can analyze contextual data with regards to the match (e.g., ETA, ETA progress, whether the transport provider 192 is slow-moving or stationary, etc.), profile data of the requesting user 197 (e.g., indicating cancelation history, price sensitivity, willingness to use alternative options, etc.), and/or current marketplace conditions to determine the cause(s) of the cancelation (320).

Based on the analysis, the treatment response generator 140 of the computing system 100 can initiate an interactive mode (e.g., via the service app 196) to communicate with the requesting user 197 and attempt to fulfill the transport request (325). In the interactive mode, the treatment response generator 140 of the computing system 100 can transmit one or more individualized, contextual notifications to explain the cause(s) of the delay (e.g., traffic conditions, non-responsive transport provider 192, etc.) and provide the requesting user 197 with one or more alternative options (e.g., for the same and or difference transport service types) and/or recommendations (e.g., based on the transport supply for different service types in the vicinity of the requesting user 197) (330). The treatment response generator 140 of the computing system 100 may then receive a user selection of either the same transport service type as configured in the original transport request (e.g., standard rideshare), or an alternative transport service type based on the recommendation or list of options provided (335). For each listed option, the matching engine 120 of the computing system 100 can automatically input the pickup location and the destination of the original transport request.

Based on the user selection, the matching engine 120 of the computing system 100 can initiate a new matching process to match the requesting user 197 with an alternative transport provider 192 (340). In certain implementations, if the requesting user 197 selects the same service type, the matching engine 120 of the computing system 100 may also automatically exclude the transport provider 192 matched in the original transport request from the candidate set. In certain scenarios, the matching engine 120 of the computing system 100 may determine that a transport provider 192 matched with a different requesting user 197, and currently en route to a pickup location of the different requesting user 197, may be more optimal for the requesting user 197 than the matched transport provider 192 of the requesting user 197. In such a scenario, the matching engine 120 of the computing system 100 can execute a trip swap between the two matches and reassign the transport provider 192 accordingly (342). In other scenarios, the computing system 100 may select an optimal transport provider 192 from a candidate set, as described above (344). Upon matching the requesting user 197, the matching engine 120 of the computing system 100 can transmit a confirmation to the requesting user 197 indicating the matching transport provider 192 and a new ETA to the pickup location (345).

FIG. 3B is a flow chart describing a post-match method of predicting and preempting cancelation to fulfill a transport request, according to examples described herein. Referring to FIG. 3B, the matching engine 120 of the computing system 100 can receive a transport request from a requesting user 197 (350), and perform a matching process to match the requesting user 197 with an optimal transport provider 192 (355). The intention prediction engine 130 of the computing system 100 may further execute a cancelation prediction model 132 using contextual data with regards to the match (360). As provided herein, the contextual data can comprise profile data of the requesting user 197 and/or transport provider 192 (e.g., indicating the user-specific attributes of the requesting user 197 and transport provider 192 respectively) (361), marketplace data in the vicinity of the requesting user 197 (362), input data corresponding to the user's and/or transport provider's interactions with the service app 196 and provider app 191 respectively (363), and delay data corresponding to a lengthy ETA of the transport provider 192 (e.g., traffic conditions, weather conditions, slow-moving or stationary transport provider 192, etc.) (364). Furthermore, in certain implementations, the intention prediction engine 130 of the computing system 100 can execute the predictive model 132 for the transport provider 192 as well as the requesting user 197. Thus, periodically or continuously, the predictive model 132 can output two cancelation probabilities—one for the requesting user 197 and one for the transport provider 192.

Subsequent to the match, the intention prediction engine 130 of the computing system 100 can determine whether a confidence threshold is exceeded for the cancelation probability of either the requesting user 197 or the transport provider 192 (365). If not (367), then the computing system 100 can continue to monitor transport provider progress to the pickup location and the marketplace data for potential alternative service options, and continue to execute the predictive model 132 (370). However, if the confidence threshold is exceeded (369), the treatment content generator 140 of the computing system 100 can initiate an interactive mode to preempt or mitigate the predicted cancelation (375).

In the interactive mode, the treatment content generator 140 of the computing system 100 can determine a set of alternative transport options based on the current marketplace conditions in the vicinity of the requesting user 197 (380). Based on the alternative transport options, the profile data of the requesting user 197, and the ETAs of the transport providers 192 in the alternative set, the treatment content generator 140 of the computing system 100 can transmit a recommendation indicating an alternative transport option (382). As provided herein, the alternative option can be the same type of transport option as the option configured in the transport request (e.g., standard rideshare), or can comprise a different type of transport option (e.g., an upgraded option, such as the luxury vehicle option, or a downgraded option, such as carpool). For example, the treatment content generator 140 of the computing system 100 can analyze the profile data of the requesting user 197 to determine any service type preferences and/or willingness to utilize difference service types.

Additionally or alternatively, the treatment content generator 140 of the computing system 100 may select a subset of the alternative transport options and present the subset to the requesting user 197 as a selectable list of options that enables the requesting user 197 to choose based on current preference (384). Whether the recommendation or the options list is presented to the requesting user 197, the treatment content generator 140 of the computing system 100 can receive data indicating a selection by the requesting user 197 (385), which can either be of the same service type as indicated in the original transport request (387) or a different service type (389). In response, the matching engine 120 of the computing system 100 can match the requesting user 197 with an optimal transport provider 192 of the selected service type (390).

In certain scenarios, the matching engine 120 of the computing system 100 may determine that a transport provider 192 matched with a different requesting user 197, and currently en route to a pickup location of the different requesting user 197, may be more optimal for the requesting user 197 that the matched transport provider 192 of the requesting user 197. In such a scenario, the matching engine 120 of the computing system 100 can execute a trip swap between the two matches and reassign the transport provider 192 accordingly (392). In other scenarios, the matching engine 120 of the computing system 100 may select an optimal transport provider 192 from a candidate set, as described above (394). The matching engine 120 of the computing system 100 may then transmit a confirmation to the requesting user 197 indicating the match and an ETA to the pickup location.

### GRAPHICAL USER INTERFACE EXAMPLES

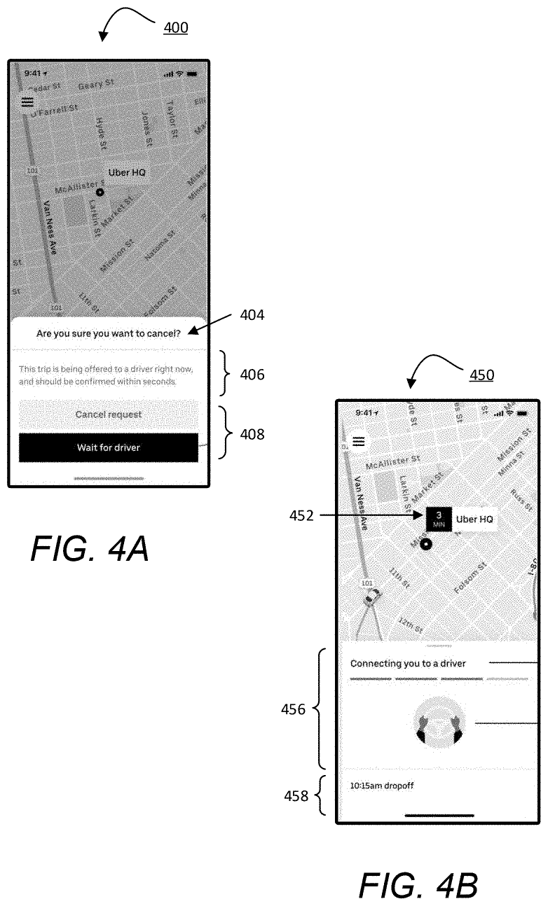

FIGS. 4A and 4B depict user interfaces showing interactive features and updates prior to a match, in accordance with examples described herein. Referring to FIG. 4A, a user interface 400 is presented to the requesting user 197 (e.g., via the service app 196) prior to a match based on either a cancelation input being received from the requesting user 197, or a predictive trigger predicting a cancelation. The user interface 400 comprises a contextual notification 406 that provides the requesting user 197 with context regarding the current status of the matching process. In the example shown, a transport provider 192 has been selected, a transport invitation has been transmitted, and the computing system 100 is awaiting a reply. The user interface 400 provides a query 404 that enables the requesting user 197 to decide whether to cancel based on the contextual notification 406, and an input section 408 that enables the requesting user 197 to input the selection.

Referring to FIG. 4B, a user interface 450 is presented in response to the requesting user 197 inputting a selection to wait for the transport provider 192 in the input section 408 of FIG. 4A. The user interface 450 includes a contextual section 456 that indicates the current status of the matching process, and an estimated time of drop-off 458 at the requesting user's inputted destination. The user interface 450 further includes a relative location and ETA 452 of the transport provider 192 to which the transport invitation has be sent.

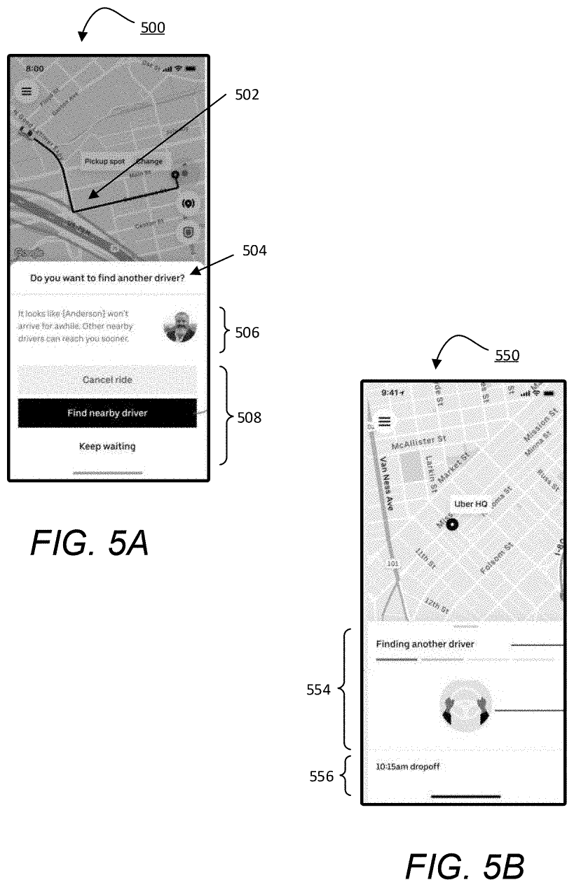

FIGS. 5A and 5B depict user interfaces showing interactive features and updates after a match, in accordance with examples described herein. Referring to FIG. 5A, a user interface 500 is presented to requesting user 197 after a match based on either a cancelation input by the requesting user 197 or transport provider 192, or a predictive trigger predicting a cancelation. The user interface 500 includes a map 502 showing a current route of the transport provider 192 to the pickup location of the requesting user 197. The user interface 500 further includes a query 504 providing the requesting user 197 with a choice based on a contextual notification 506 providing context regarding the current status of the match. The contextual notification 506 indicates that another driver can arrive at the pickup location sooner than a currently matched transport provider 192. The user interface 500 also includes a selection section 508 that enables the requesting user 197 to select between canceling the ride, re-matching the user 197 with a closer transport provider 192, or continue waiting for the currently matched transport provider 192.

Referring to FIG. 5B, a user interface 550 is presented based on the requesting user 197 selecting the re-match icon in the selection section 508 of FIG. 5A. The user interface 550 includes a contextual portion 554 indicating a current status of the re-match, and a new estimated time to drop-off 556 for the requesting user 197.

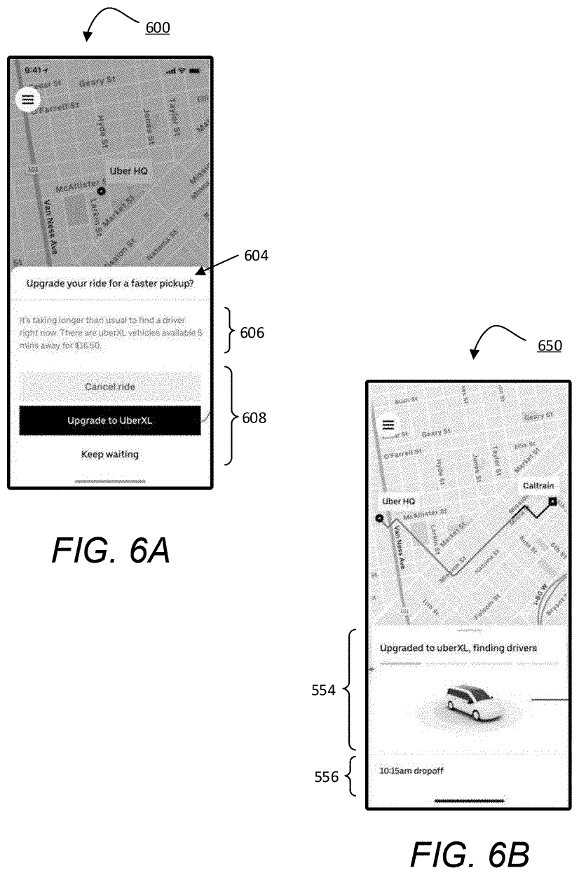

FIGS. 6A and 6B depict user interface showing interactive features presenting an alternative service option, in accordance with examples described herein. Referring to FIG. 6A, a user interface 600 is presented to the requesting user 197 prior to a match in response to either a cancelation input by the requesting user 197, or a predictive trigger predicting a cancelation by the requesting user 197 or the matching engine 120. The user interface 600 includes a contextual notification 606 indicating the status of the matching process and providing the requesting user 197 with marketplace information and a cost for another service type. The user interface 600 includes a query 604 asking the requesting user 197 whether an upgraded type is more desirable than awaiting the inputted service type in the transport request. The user interface 600 further includes a selection section 608 that enables the requesting user 197 to select between canceling the ride, upgrading to the different service type, or keep waiting for a match.

Referring to FIG. 6B, a user interface 650 is presented to the requesting user 197 in response to the requesting user 197 selecting the upgrade icon in the selection section 608 of FIG. 6A. The user interface 650 includes a status portion 554 providing the requesting user 197 with a current status of the new matching process, and a new estimated time to drop-off 556.

### HARDWARE DIAGRAMS

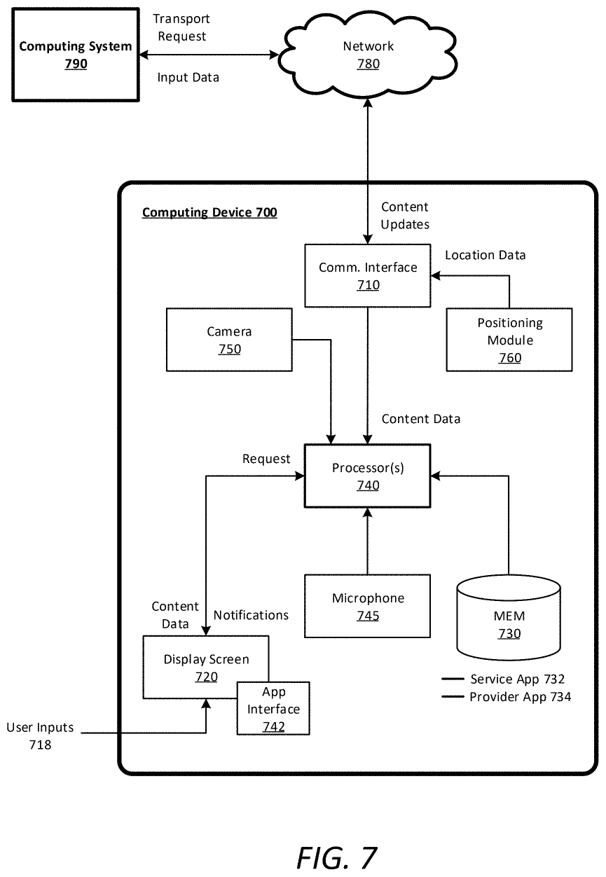

FIG. 7 is a block diagram illustrating an example mobile computing device, in accordance with examples described herein. In many implementations, the mobile computing device 700 can comprise a smartphone, tablet computer, laptop computer, VR or AR headset device, and the like. In the context of FIG. 1, the user device 195 and/or the provider device 190 may be implemented using a mobile computing device 700 as illustrated in and described with respect to FIG. 7.

According to embodiments, the mobile computing device 700 can include typical telephony features such as a microphone 745, a camera 750, and a communication interface 710 to communicate with external entities (e.g., computing system 790 implementing the on-demand transport service) using any number of wireless communication protocols. The mobile computing device 700 can store a designated application (e.g., a service application 732 or provider application 734) in a local memory 730. The service application 732 can be selected and executed by a processor 740 to generate an app interface 742 on a display screen 720, which enables the requesting user 197 to engage with the on-demand transport service and configure and submit a transport request. The provider application 734 can be selected by a transport provider 192 to receive and accept or decline transport invitations to service transport requests.

In response to a user input 718, the service application 732 can be executed by the processor 740, which can cause the application interface 742 to be generated on the display screen 720 of the mobile computing device 700. In implementations of the mobile computing device 700 as a provider device, the application interface 742 can enable a transport provider to, for example, accept or decline invitations to fulfill transport requests generated by the computing system 790. The invitations can be received as incoming service messages or notifications and acceptances of the invitations can be transmitted by the mobile computing device 700 to the computing system 790 as an outgoing service message.

In various examples, the mobile computing device 700 can include a positioning module 760, which can provide location data indicating the current location of the mobile computing device 700 to the computing system 790 over a network 780. In some implementations, location-aware or geolocation resources such as GPS, GLONASS, GALILEO, or BEIDOU can be implemented as the positioning module 760. The computing system 790 can utilize the current location of the mobile computing device 700 to manage the on-demand transport service (e.g., selecting transport providers to fulfill transport requests, routing transport providers 192 and/or requesting users 197, determining pickup and drop-off locations for users, etc.).

The communication interface 710 is configured to transmit transport requests and input data of the user over the network 780, and receive content updates from the computing system 790 in response. Additionally, the communication interface 710 can receive a content update based on a predicted cancelation trigger by the computing system 790. Based on receiving the content updates, the mobile computing device 700 can display a user interface comprising the contextual notification or recommendation on the display screen 720. The requesting user 197 can interact with the user interface via user inputs 718 (e.g., a tap gesture, a swipe gesture, etc.).

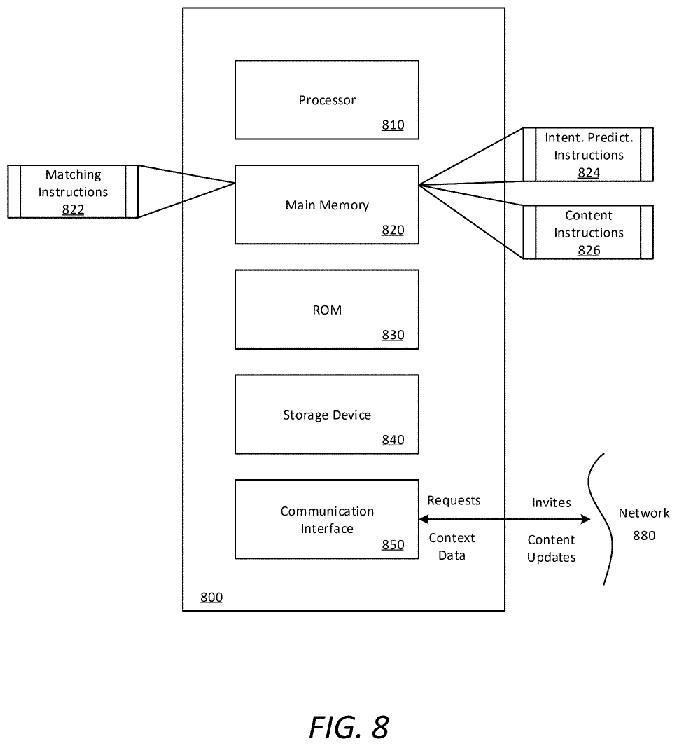

FIG. 8 is a block diagram that illustrates a computer system 800 upon which examples described herein may be implemented. A computer system 800 can represent, for example, hardware for a server or combination of servers that may be implemented as part of a network service for providing on-demand delivery services. In the context of FIG. 1, the computing system 100 may be implemented using a computer system 800 or combination of multiple computer systems 800 as described with respect to FIG. 8.

In one aspect, the computer system 800 includes processing resources (processor 810), a main memory 820, a memory 830, a storage device 840, and a communication interface 850. The computer system 800 includes at least one processor 810 for processing information stored in the main memory 820, such as provided by a random-access memory (RAM) or other dynamic storage device, for storing information and instructions which are executable by the processor 810. The main memory 820 also may be used for storing temporary variables or other intermediate information during execution of instructions to be executed by the processor 810. The computer system 800 may also include the memory 830 or other static storage device for storing static information and instructions for the processor 810. A storage device 840, such as a magnetic disk or optical disk, is provided for storing information and instructions.

The communication interface 850 enables the computer system 800 to communicate with one or more networks 880 (e.g., a cellular network) through use of a network link (wireless or wired). Using the network link, the computer system 800 can communicate with one or more computing devices and/or one or more servers. In accordance with some examples, the computer system 800 receives transport requests from mobile computing devices of requesting users. The executable instructions stored in the memory 830 can include matching instructions 822, which the processor 810 executes to receive transport requests, match the requests with transport providers, transmit transport invitations accordingly, as described throughout the present disclosure.

The executable instructions further include intention prediction instructions 824, which the processor 810 executes to compute probabilities regarding whether a cancelation will occur either prior to a match or after a match. The executable instructions can further include content generator instructions 826, which the processor 810 can execute to generate individualized treatment response content in response to receiving a cancelation or a predictive trigger of a cancelation.

By way of example, the instructions and data stored in the memory 820 can be executed by the processor 810 to implement an example network system 100 of FIG. 1. In performing the operations, the processor 810 can handle menu item requests and provider statuses and submit service invitations to facilitate fulfilling the menu item requests. The processor 810 executes instructions for the software and/or other logic to perform one or more processes, steps and other functions described with implementations provided throughout the present disclosure.

Examples described herein are related to the use of the computer system 800 for implementing the techniques described herein. According to one example, those techniques are performed by the computer system 800 in response to the processor 810 executing one or more sequences of one or more instructions contained in the main memory 820. Such instructions may be read into the main memory 820 from another machine-readable medium, such as the storage device 840. Execution of the sequences of instructions contained in the main memory 820 causes the processor 810 to perform the process steps described herein. In alternative implementations, hard-wired circuitry may be used in place of or in combination with software instructions to implement examples described herein. Thus, the examples described are not limited to any specific combination of hardware circuitry and software.

By performing the functions and techniques described herein, the computer system 800 is configured to receive requests from user devices over the network 880 and identify appropriate service providers (e.g., based on transport provider locations received from provider devices over the network 880). The computer system can transmit invitations to the identified transport providers to invite the identified transport providers to fulfill the transport requests. In addition, the computer system 800 can generate content update data to cause a user device to present contextual notifications and/or recommendations that are specifically determined for the given user operating the user device.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system, comprising:
a network communication interface to communicate, over one or more networks, with (i) computing devices of requesting users of a transport service, and (ii) computing devices of transport providers of the transport service;
a database storing user profiles for the requesting users, each user profile for each corresponding requesting user indicating one or more attributes of the corresponding requesting user;
one or more processors; and
a memory storing instructions that, when executed by the one or more processors, cause the computing system to:
receive, over the one or more networks, a transport request from the computing device of a requesting user, the transport request indicating a pickup location;
receive, over the one or more networks, location data from the computing devices of the transport providers, the location data indicating current locations of the transport providers;
based on the transport request and the location data, initiate a matching process to identify a transport provider;
prior to the requesting user being matched, receive, over the one or more networks, data indicating a cancelation request from the computing device of the requesting user;
in response to receiving the data indicating the cancelation request, determine one or more alternative options for fulfilling the transport request based on the one or more attributes indicated in the user profile of the requesting user; and
transmit a set of data to the computing device of the requesting user to cause a service application executing on the computing device of the requesting user to initiate an interactive mode, the interactive mode generating a set of user interface features that (i) display contextual information associated with the matching process, and (ii) provide the one or more alternative options for fulfilling the transport request.

2. The computing system of claim 1, wherein the one or more attributes of the requesting user indicate whether the requesting user has a propensity for utilizing or accepting one or more alternative transport types.

3. The computing system of claim 2, wherein the executed instructions further cause the computing system to:
determine, based on the one or more attributes of the requesting user, that the requesting user has a propensity utilizing or accepting one or more alternative transport types;
wherein the one or more alternative options for fulfilling the transport request comprise the one or more alternative transport types.

4. The computing system of claim 3, wherein each alternative transport type of the one or more alternative transport types includes an estimated time of arrival of a transport provider for the alternative transport type.

5. The computing system of claim 3, wherein the executed instructions further cause the computing system to:
receive, over the one or more networks, a user input selecting an alternative transport type from the one or more alternative transport types; and
based on the user input, initiate a second matching process to match the requesting user with a transport provider of the alternative transport type.

6. The computing system of claim 3, wherein the one or alternative transport types comprise at least one of a carpool transport type, a luxury vehicle transport type, a default rideshare transport type, or a high-capacity vehicle transport type.

7. The computing system of claim 1, wherein the contextual information indicates a cause for a delay in matching the requesting user with a transport provider.

8. A non-transitory computer-readable medium storing instructions that, when executed by one or more processors of a computing system, cause the computing system to:
communicate, over one or more networks, with (i) computing devices of requesting users of a transport service, and (ii) computing devices of transport providers of the transport service;
store, in a database, user profiles for the requesting users, each user profile for each corresponding requesting user indicating one or more attributes of the corresponding requesting user;
receive, over the one or more networks, a transport request from the computing device of a requesting user, the transport request indicating a pickup location;
receive, over the one or more networks, location data from the computing devices of the transport providers, the location data indicating current locations of the transport providers;
based on the transport request and the location data, initiate a matching process to identify a transport provider;
prior to the requesting user being matched, receive, over the one or more networks, data indicating a cancelation request from the computing device of the requesting user; and
in response to receiving the data indicating the cancelation request, determine one or more alternative options for fulfilling the transport request based on the one or more attributes indicated in the user profile of the requesting user; and
transmit a set of data to the computing device of the requesting user to cause a service application executing on the computing device of the requesting user to initiate an interactive mode, the interactive mode generating a set of user interface features that (i) display contextual information associated with the matching process, and (ii) provide the one or more alternative options for fulfilling the transport request.

9. The non-transitory computer-readable medium of claim 8, wherein the one or more attributes of the requesting user indicate whether the requesting user has a propensity for utilizing or accepting one or more alternative transport types.

10. The non-transitory computer-readable medium of claim 9, wherein the executed instructions further cause the computing system to:
determine, based on the one or more attributes of the requesting user, that the requesting user has a propensity utilizing or accepting one or more alternative transport types;
wherein the one or more alternative options for fulfilling the transport request comprise the one or more alternative transport types.

11. The non-transitory computer-readable medium of claim 10, wherein each alternative transport type of the one or more alternative transport types includes an estimated time of arrival of a transport provider for the alternative transport type.

12. The non-transitory computer-readable medium of claim 10, wherein the executed instructions further cause the computing system to:
receive, over the one or more networks, a user input selecting an alternative transport type from the one or more alternative transport types; and
based on the user input, initiate a second matching process to match the requesting user with a transport provider of the alternative transport type.

13. The non-transitory computer readable medium of claim 10, wherein the one or alternative transport types comprise at least one of a carpool transport type, a luxury vehicle transport type, a default rideshare transport type, or a high-capacity vehicle transport type.

14. The non-transitory computer-readable medium of claim 8, wherein the contextual information indicates a cause for a delay in matching the requesting user with a transport provider.

15. A computer-implemented method of managing a transport service, the method being performed by one or more processors and comprising:
communicating, over one or more networks, with (i) computing devices of requesting users of the transport service, and (ii) computing devices of transport providers of the transport service;
storing, in a database, user profiles for the requesting users, each user profile for each corresponding requesting user indicating one or more attributes of the corresponding requesting user;
receiving, over the one or more networks, a transport request from the computing device of a requesting user, the transport request indicating a pickup location;
receiving, over the one or more networks, location data from the computing devices of the transport providers, the location data indicating current locations of the transport providers;
based on the transport request and the location data, initiating a matching process to identify a transport provider;
prior to the requesting user being matched, receiving, over the one or more networks, data indicating a cancelation request from the computing device of the requesting user;
in response to receiving the cancelation input, determining one or more alternative options for fulfilling the transport request based on the one or more attributes indicated in the user profile of the requesting user; and
transmitting a set of data to the computing device of the requesting user to cause a service application executing on the computing device of the requesting user to initiate an interactive mode, the interactive mode generating a set of user interface features that (i) display contextual information associated with the matching process, and (ii) provide the one or more alternative options for fulfilling the transport request.

16. The method of claim 15, wherein the one or more attributes of the requesting user indicate whether the requesting user has a propensity for utilizing or accepting one or more alternative transport types.

17. The method of claim 16, further comprising:
determining, based on the one or more attributes of the requesting user, that the requesting user has a propensity utilizing or accepting one or more alternative transport types;
wherein the one or more alternative options for fulfilling the transport request comprise the one or more alternative transport types.

18. The method of claim 17, wherein each alternative transport type of the one or more alternative transport types includes an estimated time of arrival of a transport provider for the alternative transport type.

19. The method of claim 17, further comprising:
receiving, over the one or more networks, a user input selecting an alternative transport type from the one or more alternative transport types; and
based on the user input, initiating a second matching process to match the requesting user with a transport provider of the alternative transport type.

20. The method of claim 15, wherein the contextual information indicates a cause for a delay in matching the requesting user with a transport provider.
